(19) United States
(12) Patent Application Publication
(10) Pub. No.: US 2017/0098812 A1
(43) Pub. Date: Apr. 6, 2017

(54) BATTERY CASE, POWER STORAGE DEVICE, AND POWER STORAGE DEVICE MANUFACTURING METHOD

(71) Applicant: TAIYO YUDEN CO., LTD., Tokyo (JP)

(72) Inventors: Hisanobu Oomiya, Tokyo (JP); Hajime Hasegawa, Tokyo (JP)

(73) Assignee: TAIYO YUDEN CO., LTD., Tokyo (JP)

(21) Appl. No.: 15/285,940

(22) Filed: Oct. 5, 2016

(30) Foreign Application Priority Data
Oct. 6, 2015 (JP) 2015-198440

(51) Int. Cl. H01M 2/20; H01M 2/02

(52) U.S. Cl. CPC H01M 2/202; H01M 2/0277

(57) ABSTRACT

A battery case includes a first cover member configured to be mounted to one region of a cell, and a second cover member having a shape identical to a shape of the first cover member, the second cover member being configured to be mounted to an other region opposite to the one region of the cell and coupled to the first cover member.

### CROSS-REFERENCE TO RELATED APPLICATIONS

This application claims the benefit of priority to Japanese Patent Application No. 2015-198440, filed Oct. 6, 2015, of which full contents are incorporated herein by reference.

### BACKGROUND

Technical Field

The present disclosure relates to a battery case, a power storage device, and a power storage device manufacturing method.

Description of the Related Art

For example, a technique disclosed in Japanese Patent Application Laid-open Publication No. 2009-231143 is known as a battery case configured to be mounted to a cell. In the technique disclosed in Japanese Patent Application Laid-open Publication No. 2009-231143, a protrusion formed in one battery case and a cutout in another battery case are slid in predetermined directions, thereby coupling a plurality of battery cases.

However, in the battery case according to Japanese Patent Application Laid-open Publication No. 2009-231143, the movements in the sliding directions have no restriction, and thus separate parts are required to restrict the movements in the sliding directions. Such necessity for separate parts increases the number of manufacturing components, which complicates the management of components, etc., as well as increases the manufacturing costs.

Thus, the present disclosure is directed to provision of a battery case capable of reducing the number of components.

### SUMMARY

A battery case according to the present disclosure that includes: a first cover member configured to be mounted to one region of a cell, and a second cover member having a shape identical to a shape of the first cover member, the second cover member being configured to be mounted to an other region opposite to the one region of the cell and be coupled to the first cover member.

Other features of the present invention will become apparent from descriptions of the present specification and of the accompanying drawings.

### BRIEF DESCRIPTION OF THE DRAWINGS

For more thorough understanding of the present invention and advantages thereof, the following description should be read in conjunction with the accompanying drawings.

FIG. 1 is a perspective view illustrating a battery case according to an embodiment of the present disclosure.

FIG. 2 is a front view illustrating one cover member configuring a battery case according to an embodiment of the present disclosure.

FIG. 3 is a back view illustrating one cover member configuring a battery case according to an embodiment of the present disclosure.

FIG. 4 is a right side view illustrating one cover member configuring a battery case according to an embodiment of the present disclosure.

FIG. 5 is a left side view illustrating one cover member configuring a battery case according to an embodiment of the present disclosure.

FIG. 6 is a plan view illustrating one cover member configuring a battery case according to an embodiment of the present disclosure.

FIG. 7 is a bottom view illustrating one cover member configuring a battery case according to an embodiment of the present disclosure.

FIG. 8 is a cross-sectional view taken on line VIII-VIII of FIG. 2.

FIG. 9 is a cross-sectional view taken on line IX-IX of FIG. 2.

FIG. 10 is a perspective view illustrating one example of a state where a battery case according to an embodiment of the present disclosure is mounted to a cell, to configure a battery device.

FIG. 11 is an exploded view of a battery device illustrated in FIG. 10.

FIG. 12 is a perspective view illustrating another example of a state where battery cases according to an embodiment of the present disclosure are mounted to cells, to configure a battery device.

FIG. 13 is an exploded view of a battery device illustrated in FIG. 12.

FIG. 14 is a diagram illustrating a way of coupling battery cases according to an embodiment of the present disclosure, to configure a battery device illustrated in FIG. 12.

FIG. 15 is a partially enlarged cross-sectional view of a battery device illustrated in FIG. 12.

FIG. 16 is a perspective view illustrating still another example of a state where battery cases according to an embodiment of the present disclosure are mounted to cells, to configure a battery device.

FIG. 17 is an exploded view of a battery device illustrated in FIG. 16.

FIG. 18 is a diagram illustrating a way of coupling battery cases according to an embodiment of the present disclosure to configure a battery device illustrated in FIG. 16.

FIG. 19 is a partially enlarged cross-sectional view of a battery device illustrated in FIG. 16.

### DETAILED DESCRIPTION

At least the following matters will be apparent from descriptions of the present specification and the accompanying drawings.

### Description of Embodiments

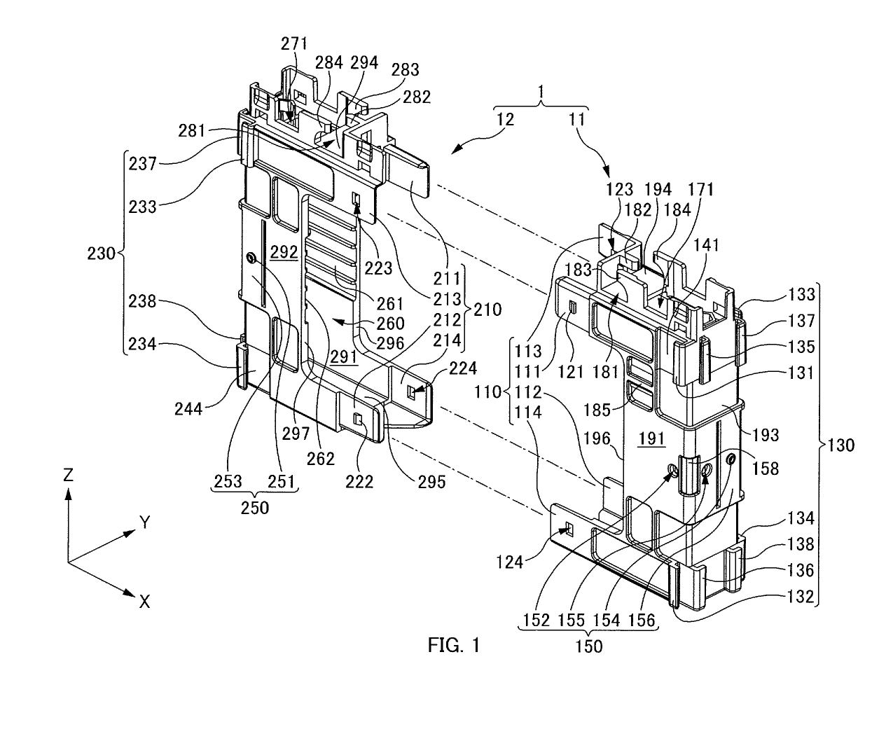

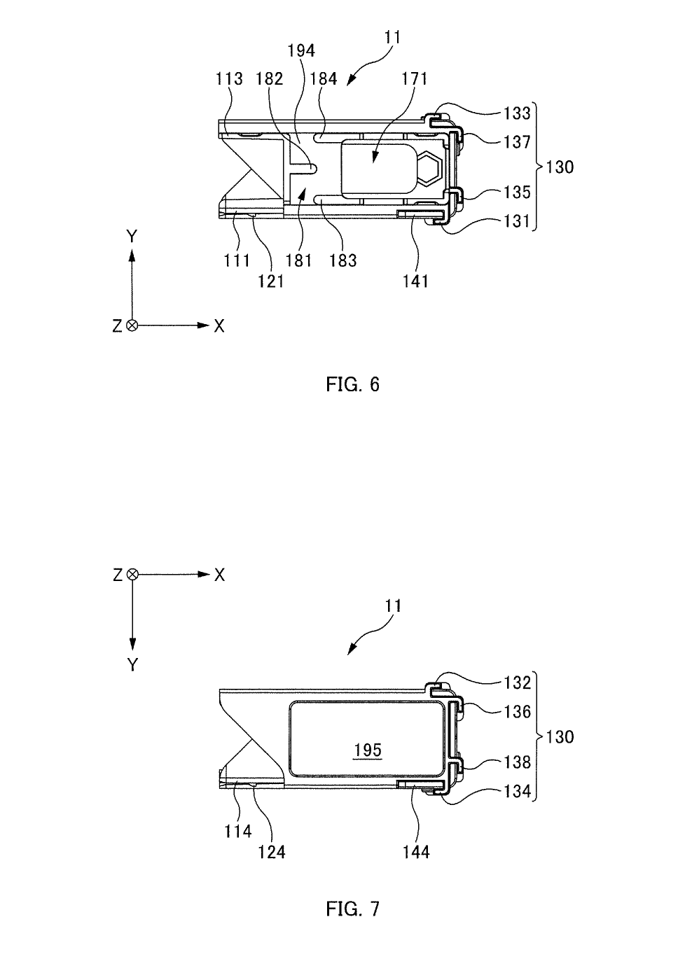

Hereinafter, various embodiments will be described with reference to diagrams as needed. Common or similar components are given the same or similar reference numerals. Further, in FIGS. 1 to 19, a Z-axis direction is defined as a vertical direction, an X-axis direction is defined as a direction in which a cell (battery) is inserted into a cover member, and a Y direction is defined as a direction orthogonal to the X-axis and the Z-axis. Here, the positive side in the X-axis direction may be referred to as right, the negative side in the X-axis direction as left, the negative side in the Y-axis direction as front, the positive side in the Y-axis direction as back, the positive side in the Z-axis direction as up, and the negative side in the Z-axis direction as down.

### [Cell]

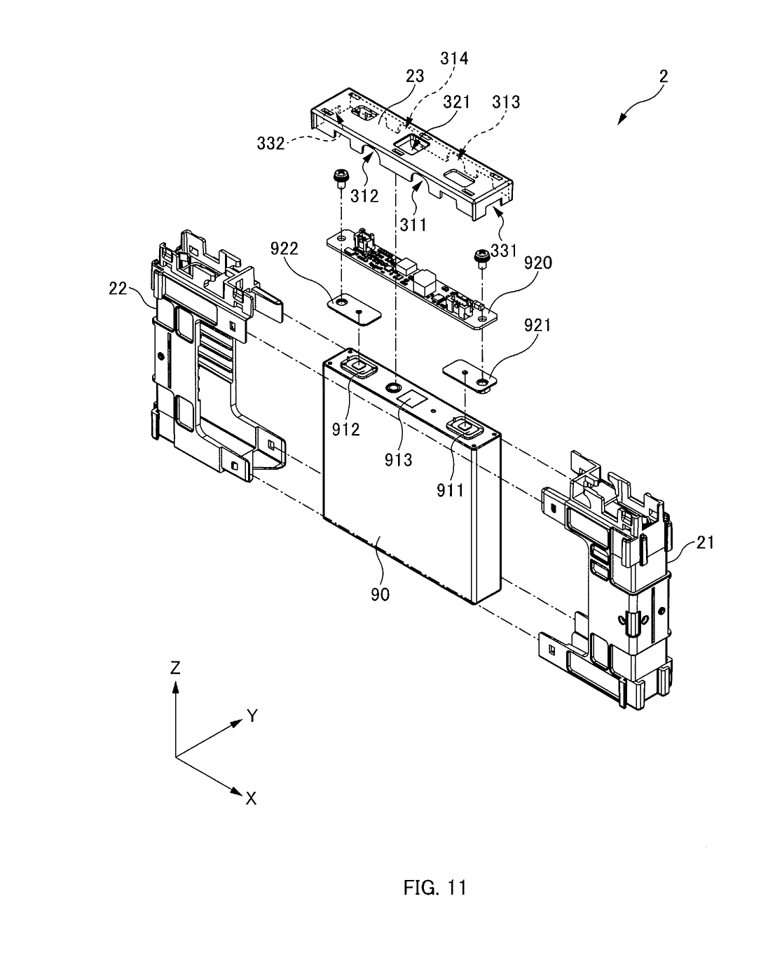

First, a cell that is used in an embodiment will be described. A cell 90 is, for example, as illustrated in FIG. 11, of a rectangular parallelepiped shape, and includes positive and negative electrodes 911, 912 and an explosion-proof mechanism 913 on a top surface. The electrodes 911, 912 correspond to a first electrode and a second electrode, respectively.

### [Configuration of Battery Case]

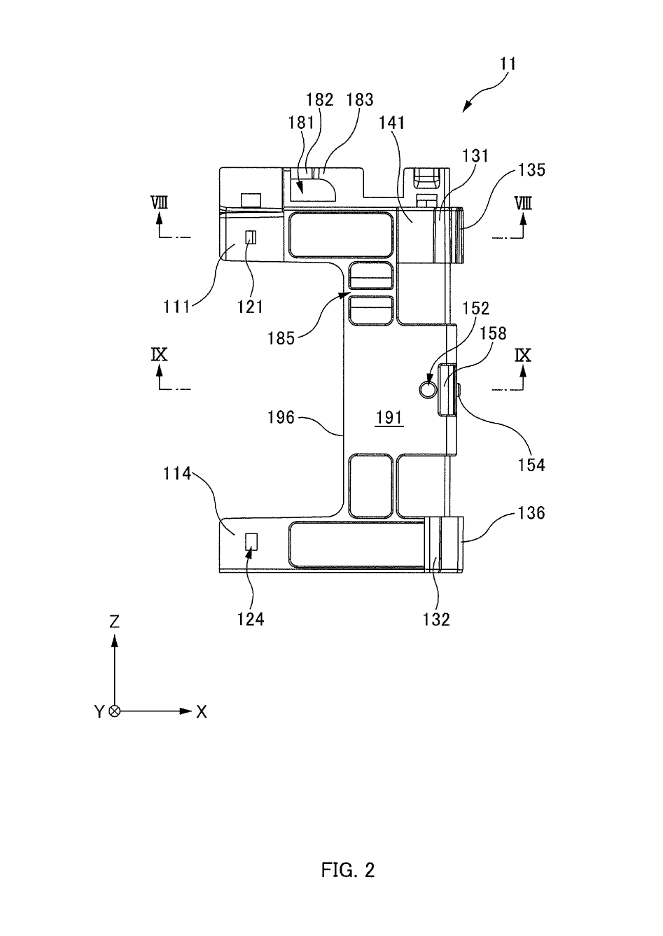

A configuration of a battery case according to an embodiment of the present disclosure will be described with reference to FIGS. 1 to 9. FIG. 1 is a diagram illustrating the battery case according to an embodiment of the present disclosure, and FIGS. 2 to 9 are diagrams illustrating a first cover member configuring a battery case. In the following description, battery cases 1 to 8 are collectively referred to as a battery case 10. Further, a first cover member, a second cover member, and an electrode cover, which can be included in the battery cases 1 to 8, may collectively be referred to as a first cover member 100, a second cover member 200, and an electrode cover 300, respectively. Note that the battery cases 2 to 8 each include the first cover member and the second cover member configuring the battery case 1, and thus the detail descriptions thereof are omitted.

The battery case 1 is a cover configured to be mounted to the cell 90 in such a manner as to cover it, and is in a rectangular parallelepiped shape as a whole. That is, the cell 90 is housed in an interior space formed by the first cover member and the second cover member. Further, the cell and the first and second cover member configures a power storage device. Here, the length in the Z-axis direction of the battery case 1 may be referred to as the height of the battery case 1, the length in the X-axis direction of the battery case 1 may be referred to as the width of the battery case 1, and the length in the Y-axis direction of the battery case 1 may be referred to as the thickness of the battery case 1.

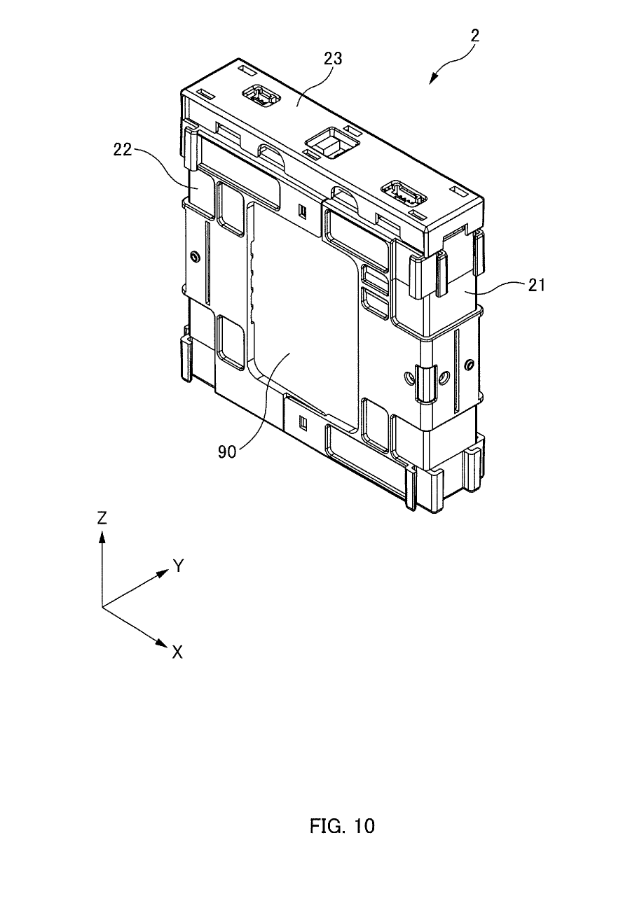

The battery case 1 includes, as illustrated in FIG. 1, a first cover member 11, and a second cover member 12 having the same shape of that of the first cover member 11. The first cover member 11 and the second cover member 12 are, for example, resin members, and are formed using the same mold. Then, the first cover member 11 is configured to be mounted to one region in the cell 90, while the second cover member 12 is configured to be mounted to the other region, opposite to the one region, in the cell 90, as well as is coupled to the first cover member 11. In an embodiment, for example, as illustrated in FIG. 10, the first cover member 11 is mounted in such a manner as to cover the cell 90 on the right side, while the second cover member 12 is mounted in such a manner as to cover the cell 90 on the left side.

As has been described above, the first cover member 11 and the second cover member 12 have the same shape, and thus, hereinafter, description will be made focusing on the first cover member 11. Note that the constituent elements of the second cover member 12 in a state mounted to the cell 90 are illustrated in a manner symmetrical to the constituent elements of the first cover member 11 with respect to the Z-axis.

### <First Cover Member>

The first cover member 11 includes a front wall 191, a back wall 192, a right wall 193, an upper wall 194, and a lower wall 195, to be formed in a rectangular parallelepiped shape as a whole. The front wall 191 and the back wall 192 are arranged to be parallel to an XZ plane. The right wall 193 connects the right edges of the front wall 191 and the back wall 192 to each other, and is provided to be parallel to a YZ plane. The upper wall 194 connects the upper edges of the front wall 191 and the back wall 192 to each other, the lower wall 195 connects the lower edges of the front wall 191 and the back wall 192 to each other, and both are provided to be parallel to an XY plane. Then, the left edge of the first cover member 11 forms a first opening 160, into which one region of the cell 90 (here, the right side of the cell 90) is to be inserted.

The first cover member 11 as such includes a first locking unit 110, a first coupling unit 130, and a restricting unit 150. Hereinafter, descriptions will be made in the order of the first locking unit 110, the first coupling unit 130, and the restricting unit 150.

### (First Locking Unit)

The first locking unit 110 is formed at the end of (near) the first opening 160. Similarly, a second locking unit 210, which is to be locked (latched) with the first locking unit 110, is formed at the end of (near) a second opening 260 in the second cover member 12. The first locking unit 110 and the second locking unit 210 are locked with each other, thereby coupling the first cover member 11 and the second cover member 12.

Specifically, the first locking unit 110 includes, as illustrated in FIG. 1, four lock pieces 111 to 114 extending from an end (edge) of the first opening 160 along the outer surfaces of the front wall 191 and the back wall 192. The lock piece 111 is arranged on the upper part of the front wall 191, the lock piece 112 is arranged on the lower part of the back wall 192, the lock piece 113 is arranged on the upper part of the back wall 192, and the lock piece 114 is arranged on the lower part of the front wall 191. Similarly, the second locking unit 210 of the second cover member 12 includes lock pieces 211 to 214. However, the lock pieces 211 to 214 of the second cover member 12 are arranged in a manner symmetrical to the lock pieces 111 to 114 of the first cover member 11 with respect to the Z-axis.

The lock piece 111 includes, as illustrated in FIG. 1, a hook part 121 protruding outside of the battery case 1 (i.e., the negative direction in the Y-axis intersecting a direction in which the battery case 1 is to be inserted). The lock piece 112 also includes a hook part 122 protruding outside of the battery case 1 (in the positive direction in the Y-axis). Similarly, in the second cover member 12, a lock piece 211 includes a hook part 221 protruding in the positive direction in the Y-axis, similarly to the hook part 121, and a lock piece 212 includes a hook part 222 protruding in the negative direction in the Y-axis, similarly to the hook part 122.

On the other hand, the lock piece 113 includes a hole 123 into/on which the tip of the hook part 221 in the second cover member 12 is to be fitted/hooked. The lock piece 114 also includes a hole 124 into/on which the tip of the hook part 222 in the second cover member 12 is to be fitted/hooked. Similarly, in the second cover member 12, the lock piece 213 includes a hole 223 into/on which the tip of the hook part 121 in the first cover member 11 is to be fitted/hooked, and the lock piece 214 includes a hole 224 into/on which the tip of the hook part 122 in the first cover member 11 is to be fitted/hooked. Note that the hook parts 121, 122 correspond to a first protrusion portion, the holes 123, 124 correspond to a first hole portion, the hook parts 221, 222 correspond to a second protrusion portion, and the holes 223, 224 correspond to a second hole.

With the first locking unit 110 and the second locking unit 210 as such, the first cover member 11 and the second cover member 12 can be kept in a state coupled to each other.

### (First Coupling Unit)

The first cover member 11 includes the first coupling unit 130 configured to couple the battery case 1 to another battery case 1. In an embodiment, the battery cases 1 are coupled in the thickness direction (first direction) and the width direction (second direction) thereof. Thus, when the battery cases 1 are coupled in the thickness direction, the first coupling unit 130 can couple the first cover member 11 and the first cover member 11 configuring another battery case 1, in a state immediately adjacent to each other. Further, when the battery cases 1 are coupled in the width direction, the first coupling unit 130 can couple the first cover member 11 and the second cover member 12 configuring another battery case 1, in a state immediately adjacent to each other. Note that, in the first coupling unit 130, the elements for coupling the battery cases 1 in the thickness direction may be referred to as a third coupling unit, and the elements for coupling the battery cases 1 in the width direction may be referred to as a fourth coupling unit. Similarly, in a second coupling unit 230, the elements for coupling the battery cases 1 in the thickness direction may be referred to as a fifth coupling unit, and the elements for coupling the battery cases 1 in the width direction may be referred to as a the sixth coupling unit.

The first coupling unit 130 includes eight substantially L-shape units 131 to 138. The substantially L-shape units 131, 132 are provided to the front wall 191 and the substantially L-shape units 133, 134 are provided to the back wall 192, so that the battery cases 1 are detachably coupled in the thickness direction. Further, the substantially L-shape units 135 to 138 are provided to the right wall 193 so that the battery cases 1 are detachably coupled in the width direction. Similarly, the second coupling unit 230 includes substantially L-shape units 231 to 238. However, the substantially L-shape units 231 to 238 are arranged in a manner symmetrical to the substantially L-shape units 131 to 138 of the first coupling unit with respect to the Z-axis. Here, the substantially L-shape units 131 to 134 correspond to a first substantially L-shape unit, and are included in the third coupling unit. The substantially L-shape units 231 to 234 correspond to a second substantially L-shape unit, and are included in the fifth coupling unit. The substantially L-shape units 135 to 138 correspond to a third substantially L-shape unit, and are included in the fourth coupling unit. The substantially L-shape units 235 to 238 correspond to a fourth substantially L-shape unit, and are included in the sixth coupling unit.

Specifically, the substantially L-shape unit 131, as illustrated in FIG. 1, rises from the upper part of the front wall 191 along the right wall 193, and bends toward the second cover member 12. The substantially L-shape unit 132, as illustrated in FIG. 1, rises from the lower part of the front wall 191 in a manner parallel to the right wall 193, and bends in a direction opposite to that of the substantially L-shape unit 131. Note that, as illustrated in FIG. 1, the vicinity of the substantially L-shape unit 131 is depressed more than the front wall 191, to form a depressed portion 141.

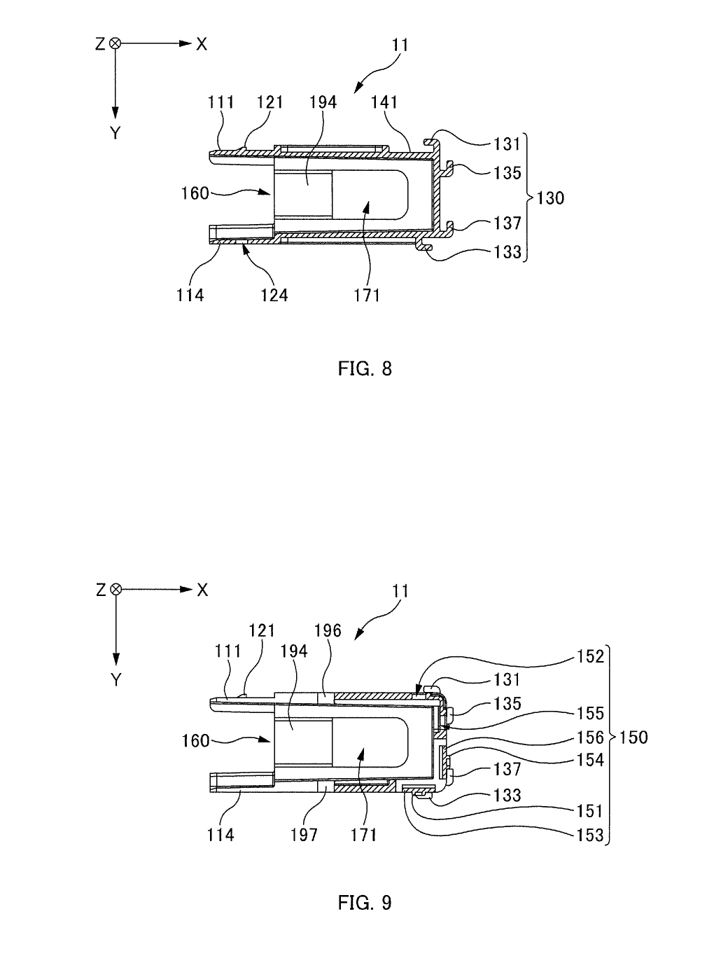

Further, the substantially L-shape unit 133, as illustrated in FIG. 8, rises from the upper part of the back wall 192 in a manner parallel to the right wall 193, and bends in a direction opposite to that of the substantially L-shape unit 131. The substantially L-shape unit 134, as illustrated in FIG. 7, rises from the lower part of the back wall 192 along the right wall 193, and bends toward the second cover member 12 similarly to the substantially L-shape unit 131. Note that, as illustrated in FIG. 7, the vicinity of the substantially L-shape unit 134 is depressed more than the back wall 192, to form a depression portion 144.

With such substantially L-shape units 131 to 134, for example, when the battery case 1 is coupled to another battery case 1 on the back wall 192 side, the tips of the substantially L-shape units 133, 134 of the battery case 1 are locked (engaged) with the tips of the substantially L-shape units 131, 132 of another battery case 1. Note that the procedure of coupling the battery cases 1 in the thickness direction and the procedure of releasing such coupling will be described in relation to a usage mode 2, which will be described later.

Next, the substantially L-shape units 135 to 138 will be described. As illustrated in FIG. 1, the substantially L-shape units 135, 137 are provided to the upper part of the right wall 193, and the substantially L-shape units 136, 138 are provided to the lower part of the right wall 193. Then, the substantially L-shape unit 135 rises from the vicinity of the boundary between the front wall 191 and the right wall 193 in a manner parallel to the front wall 191, and bends toward the substantially L-shape unit 131 (i.e., toward the negative direction in the Y-axis). The substantially L-shape unit 137 rises from the boundary between the back wall 192 and the right wall 193 along the back wall 192, and bends in the same direction as that of the substantially L-shape unit 135.

Further, the substantially L-shape unit 136 rises from the boundary between the front wall 191 and the right wall 193 along the front wall 191 in a parallel manner, and bends in a direction opposite to that of the substantially L-shape unit 135. The substantially L-shape unit 138 rises from the vicinity of the boundary between the back wall 192 and the right wall 193 in a manner parallel to back wall 191, and bends in a direction opposite to that of the substantially L-shape unit 135, similarly to the substantially L-shape unit 136.

With such substantially L-shape units 135 to 138, for example, when the battery case 1 is coupled to another battery case 1 at the right wall 193, the tips of the substantially L-shape units 135, 136, 137, 138 in the battery case 1 are locked (engaged) with the tips of the substantially L-shape units 237, 238, 235, 236 of the second cover member 12 in another battery case 1. Note that the procedure of coupling the battery case 1 in the left and right direction and the procedure of releasing such coupling will be described in relation to a usage mode 3, which will be described later.

### (Restricting Unit)

The restricting unit 150 is configured to restrict deviation of the battery case 1 from another battery case 1 that is coupled in a manner immediately adjacent thereto, and includes a first restricting unit and a third restricting unit. Similarly, a restricting unit 250 in the second cover member 12 includes a second restricting unit corresponding to the first restricting unit and a fourth restricting unit corresponding to the third restricting unit.

The first restricting unit is a member configured to restrict deviation from the immediately adjacent first cover member 11 together with the substantially L-shape units 131 to 134, and, as illustrated in FIG. 1, includes a restricting protrusion portion 151, a restricting hole portion 152, and a leaf spring 153. Further, the third restricting unit is a member configured to restrict deviation from the immediately adjacent second cover member 12 together with the substantially L-shape units 135 to 138, and includes a restricting protrusion portion 154, a restricting hole portion 155, and a leaf spring 156. Similarly, the second restricting unit in the second cover member 12 is a member configured to restrict deviation from the immediately adjacent second cover member 12 together with the substantially L-shape units 231 to 234, and includes a restricting protrusion portion 251, a restricting hole portion 252, and a leaf spring 253. Further, the fourth restricting unit is a member configured to restrict deviation from the immediately adjacent first cover member 11 together with the substantially L-shape units 235 to 238, and includes a restricting protrusion portion 254, a restricting hole portion 255, and a leaf spring 256. Note that the leaf springs 153, 156, 253, 256 are one example of an elastic body.

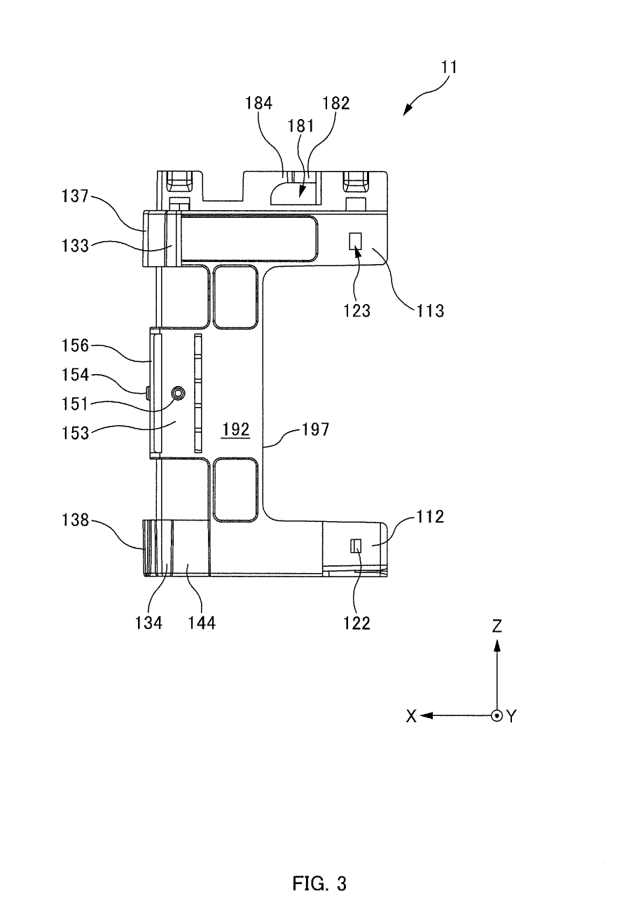

Specifically, the restricting protrusion portion 151 and the leaf spring 153 are provided, as illustrated in FIG. 3, between the substantially L-shape units 133, 134 in the back wall 192. The restricting hole portion 152 is provided, as illustrated in FIG. 2, between the substantially L-shape units 131, 132 in the front wall 191. The location at which the restricting protrusion portion 151 is provided and the location at which the restricting hole portion 152 is provided are aligned along the X-axis. Note that the restricting protrusion portion 251 and the leaf spring 253 in the second cover member 12 are provided between the substantially L-shape units 233, 234 in a back wall 292. The restricting hole portion 252 is provided between the substantially L-shape units 231, 232 in a front wall 291.

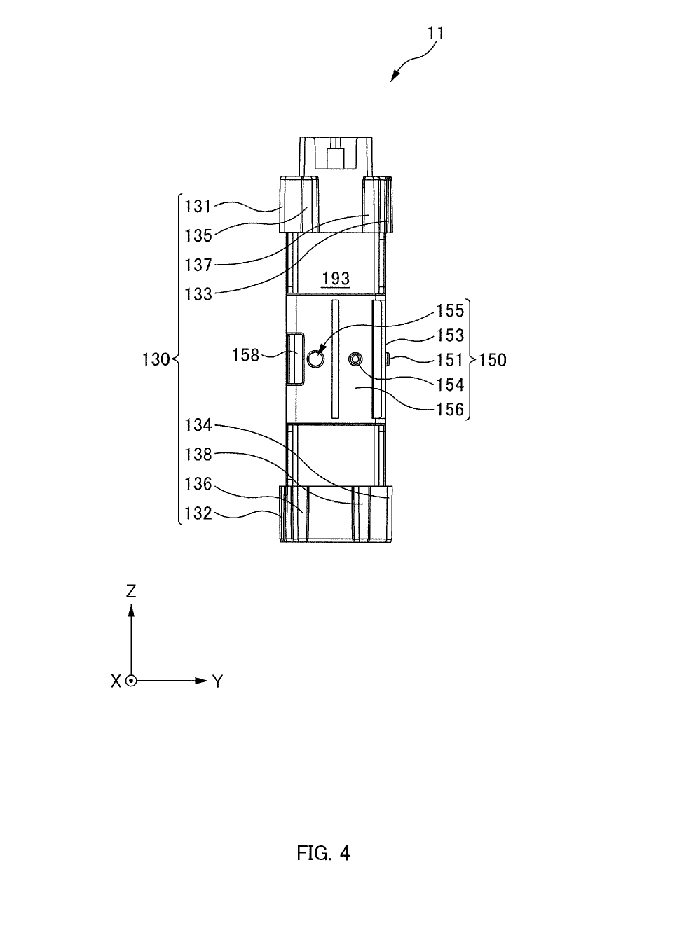

The restricting protrusion portion 151, as illustrated in FIGS. 4 and 9, protrudes outside of the battery case 1 from the leaf spring 153, and is configured to be fitted into the restricting hole portion 152 of another battery case 1 that is coupled to the battery case 1 in the thickness direction. Then, deviation of the battery case 1 with respect to another battery case 1 is restricted, with the restricting hole portion 252 of the second cover member 12 being fitted with the restricting protrusion portion 251 of another battery case 1.

The leaf spring 153 is an example of a member configured to be elastically deformed when being thrusted in the thickness direction of the battery case 1, and functions when a plurality of the battery cases 1 are coupled in the thickness direction. That is, the leaf spring 153 is an example of a first elastic portion, and is configured to, when a plurality of the battery cases 1 are coupled, be elastically deformed in such a manner as to move the restricting protrusion portion 151 of the first cover member 11 away from the restricting hole portion 152 of another adjacent first cover member 11, until the restricting protrusion portion 151 is fitted into the restricting hole portion 152. Similarly, the leaf spring 253 in the second cover member 12 is an example of a second elastic portion, and is configured to, when a plurality of the battery cases 1 are coupled, be elastically deformed in such a manner as to move the restricting protrusion portion 251 of the second cover member 12 away from the restricting hole portion 252 of another adjacent second cover member 12, until the restricting protrusion portion 251 is fitted into the restricting hole portion 252. The function of the leaf springs 153, 253 will be describe in relation to the usage mode 2, which will be described later.

On the other hand, as illustrated in FIG. 1, the restricting protrusion portion 154, the restricting hole portion 155, and the leaf spring 156 are provided to the right wall 193. The restricting protrusion portion 154 and the leaf spring 156 are arranged between the substantially L-shape units 137, 138, and the restricting hole portion 155 is arranged between the substantially L-shape units 135, 136. Note that the restricting protrusion portion 254 and the leaf spring 256 provided to a left wall 293 of the second cover member 12 are arranged between the substantially L-shape units 237, 238, and the restricting hole portion 255 is arranged between the substantially L-shape units 235, 236.

The restricting protrusion portion 154, as illustrated in FIGS. 1 and 9, protrudes outside of the battery case 1 from the leaf spring 156 (in the positive direction in the X-axis), and is configured to be fitted into the restricting hole portion 255 of another battery case 1 that is coupled to the battery case 1 in the width direction. Further, the restricting hole portion 155 is fitted with the restricting protrusion portion 254 in another battery case 1. Accordingly, the battery case is restrained from deviating with respect to another immediately adjacent battery case 1.

The leaf spring 156 is an example of a member configured to be elastically deformed when being thrusted in the width direction of the battery case 1, and functions when a plurality of the battery cases 1 are coupled in the width direction. That is, the leaf spring 156 is an example of a third elastic portion, and is configured to, when a plurality of the battery cases are coupled, be elastically deformed in such a manner as to move the restricting protrusion portion 154 of the first cover member 11 away from the restricting hole portion 255 of another adjacent second cover member 12, until the restricting protrusion portion 154 is fitted into the restricting hole portion 255. Similarly, the leaf spring 256 in the second cover member 12 is an example of a fourth elastic portion, and is configured to, when a plurality of the battery cases are coupled, be elastically deformed in such a manner as to move the restricting protrusion portion 254 of the second cover member 12 away from the restricting hole portion 155 of another adjacent first cover member 11, until the restricting protrusion portion 254 is fitted into the restricting hole portion 155. The operations of such leaf springs 156, 256 will be described in relation to the usage mode 3, which will be described later

### (Inside of First Cover Member)

As has been described above, the first cover member 11 includes the first opening 160. The size of the first opening 160 is, as illustrated in FIG. 8, larger than the size of the cell 90 so as to facilitate insertion of the cell 90. The inner surface of the first cover member 11 comes closer to the cell 90, with distance from the first opening 160 toward the back of the first cover member 11 (in the right direction). That is, in the inner surface of the first cover member 11, a slope that is inclined in such a manner as to come closer to the cell 90 with distance from the first opening 160 in a direction in which the cell 90 is to be inserted. With such a slope, insertion of the cell 90 into the first cover member 11 is facilitated, as well as, while the first cover member 11 is mounted to the cell 90, play between the first cover member 11 and the cell 90 becomes smaller. Thus, the cell 90 can efficiently be housed in the battery case 1. Further, with such a slope, the first cover member 11 that is injection-molded can easily be released from a mold.

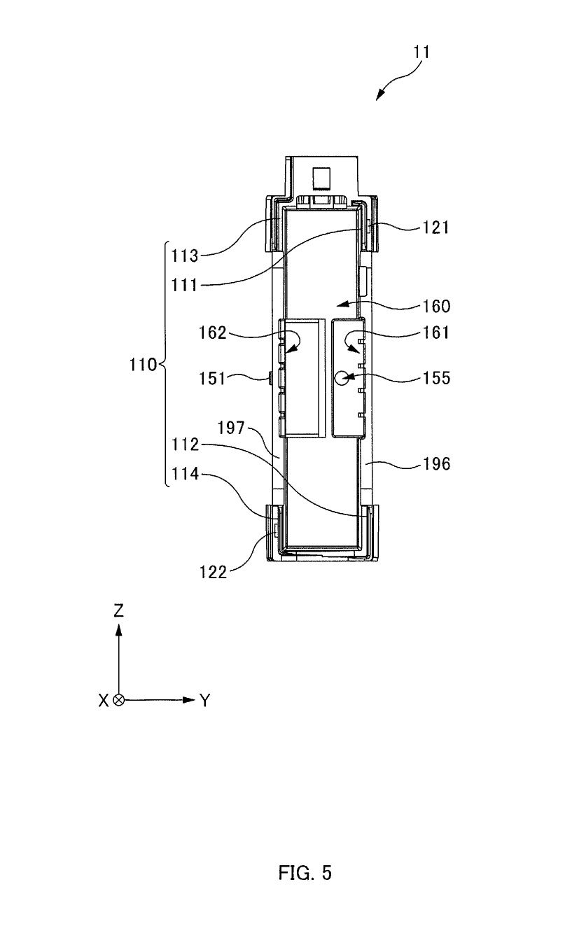

Further, as illustrated in FIG. 5, in the inner surface of the front wall 191 in the first cover member 11, several grooves 161 are formed along the X-axis direction. Further, in the inner surface of the back wall 192, several grooves 162 are formed along the X-axis direction. Similarly, in the front wall 291 and the back wall 292 of the second cover member 12, the grooves 261, 262 are formed, respectively.

Further, the first cover member 11 includes cutouts 196, 197 in the front wall 191 and the back wall 192, respectively, such that the front and back surfaces of the cell 90 mounted to the battery case 1 are partially exposed. Similarly, the second cover member 12 includes cutouts 296, 297 in the front wall 291 and the back wall 292, respectively. The cutouts 196, 197 correspond to a first cutout, and the cutouts 296, 297 correspond to a second cutout.

With the aforementioned first opening and inner surface of the first cover member 11, while the first cover member 11 and the second cover member 12 are mounted to the cell 90, the heat generated on the periphery of the cell 90 is transferred along the grooves 161, 162 to the exposed parts of the cell 90. Then, such heat is efficiently dissipated from the exposed parts of the cell 90, together with the heat generated at the central portion of the cell 90. That is, a great cooling effect can be obtained. Note that the aforementioned grooves 161, 162 contribute to the reduction in raw materials and manufacturing costs, as well as ribs formed along with these grooves 161, 162 improve the strength of the first cover member 11.

### (Other)

The first cover member 11 includes a hole 171, with which the electrode 911 is exposed, in the upper wall 194. Similarly, the second cover member 12 includes a hole 271, with which the electrode 912 is exposed, in an upper wall 294. The holes 171, 271 correspond to a third opening and a fourth opening, respectively. Through the holes 171, 271, a plate and harness are easily mounted to the electrodes 911, 912. Note that the electrodes 911, 912 are eventually covered with an electrode cover which will be described later.

Further, in the first cover member 11, a part corresponding to the explosion-proof mechanism 913 of the cell 90 is opened such that the explosion-proof mechanism 913 of the cell 90 is exposed while the first cover member 11 is coupled to the second cover member 12.

Further, on the upper wall 194 of the first cover member 11, a passage 181 through which a harness not shown is inserted is formed. The passage 181 is a passage through which a harness is to be inserted, the harness being used for electrically connecting the electrodes of the battery cases 1 that are located at the front and back ends, for example, while a plurality of the battery cases 1 are coupled in the thickness direction, and the passage 181 is the passage with which the harness is to be covered. With such a passage 181, work for handling a harness is simplified.

The passage 181 is opened on the upper side thereof so that the harness is put therein. However, a harness holding mechanism is provided on the upper side of the passage 181, so that the harness once inserted therethrough is held within the passage 181. Such a mechanism includes bar members 182 to 184. The bar member 182 extends toward the right wall 193 from a wall surface that rises from the upper wall 194 in a manner parallel to the right wall 193. Further, the bar members 183, 184 extend in a direction opposite to that of the bar member 182 from a wall surface that rises from the front wall 191 and the back wall 192, respectively.

The tip of the bar member 182 and the tips of the bar members 183, 184, as illustrated in FIGS. 2, 3 and 6, overlap when viewed from the Y-axis direction. Thus, a bent harness is easily put in/out from the passage 181 through the harness holding mechanism. Whereas, a straight harness is prevented from being put in/out from the passage 181 by the harness holding mechanism. Accordingly, the harness inserted through the passage 181 is reliably held within the passage 181.

Further, the first cover member 11 has, in the front wall 191, an attaching portion 185 on which a band (not shown) for tying a harness (not shown) is bound. Such an attaching portion 185 is attached with a band for tying a harness that electrically connect the battery cases 1 that are located on the left and right ends, for example, while a plurality of the battery cases 1 are coupled in the width direction. Accordingly, work for handling a harness is simplified.

### <Electrode Cover>

The battery case 10 may include, for example, as illustrated in FIG. 10, the electrode cover 300 configured to cover the top surfaces of the first cover member 100 and the second cover member 200. The electrode cover 300 is a member configured to cover the electrodes 911, 912 of the cell 90 so as to prevent short-circuits. The electrode cover 300, for example, as illustrated in FIG. 11, includes an opening 321 with which the explosion-proof mechanism 913 of the cell 90 is exposed, as well as includes cutouts 311 to 314 corresponding to the passages 181, 281. Further, the electrode cover 300 includes cutouts 331, 332 through which plates (e.g., 921, 922) connected to the electrodes 911, 912 of the cell 90 run.

In an embodiment according to the present disclosure, when covering the top surfaces of the first cover member 100 and the second cover member 200, the electrode cover 300 is locked to the top surfaces of the first cover member 100 and the second cover member 200 with hooks not shown. Thus, the electrode cover 300 cannot be detached from the top surfaces of the first cover member 100 and the second cover member 200, without using a tool such as a flathead screwdriver. Thus, once a battery case 10 is assembled, disassembling of the battery case 10 is difficult.

### [Usage Mode of Battery Case]

Typical modes in which the battery case 1 having a configuration described above is used will be described below. The usage modes of the battery case 10 includes three modes: a case in which the battery case 1 is used alone (usage mode 1), a case in which a plurality of the battery cases 10 are coupled in the thickness direction (usage mode 2), and a case in which a plurality of the battery cases 10 are coupled in the width direction (usage mode 3). Hereinafter, the usage mode 1 to the usage mode 3 will be described in order.

### (Usage Mode 1)

The usage mode 1, in which the battery case 10 is used alone, will be described with reference to FIGS. 10 and 11. FIG. 10 is a perspective view illustrating the usage mode 1, and FIG. 11 is an exploded view of FIG. 10.

The usage mode 1, as illustrated in FIGS. 10 and 11, a pair of battery cases 2 is mounted to the single cell 90, to form a single unit of a battery device. Specifically, a first cover member 21 is mounted to the cell 90 on the right side, a second cover member 22 is mounted to the cell 90 on the left side, and an electrode cover 23 is fitted to the top surfaces of the first cover member 21 and the second cover member 22. At this time, an adhesive may be poured to the edges inside the first cover member 21 and the second cover member 22, to bond the cell 90 to the interior of the first cover member 21 and the second cover member 22.

A control board 920 is incorporated between the first and second cover members 21, 22 and the electrode cover 23, to cause the cell 90 to function as a battery device. Further, the control board 920 and the electrode 911 are electrically connected through an electrode plate 921. Similarly, the control board 920 and the electrode 912 are electrically connected through an electrode plate 922. Note that, in the usage mode 1, as illustrated in FIG. 11, the explosion-proof mechanism 913 of the cell 90 is covered with the control board 920.

Accordingly, a battery device including a couple of battery cases is assembled. A screw is not used for assembling such a battery device, except connecting in an electrical connection part, and thus the number of assembly parts can be reduced.

### (Usage Mode 2)

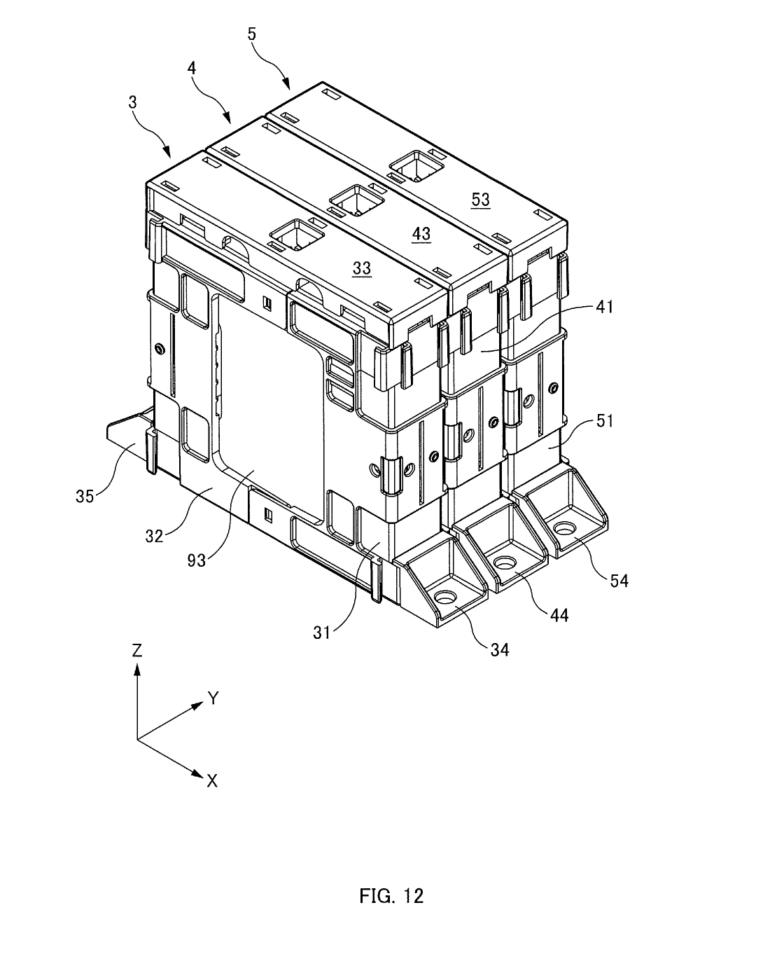

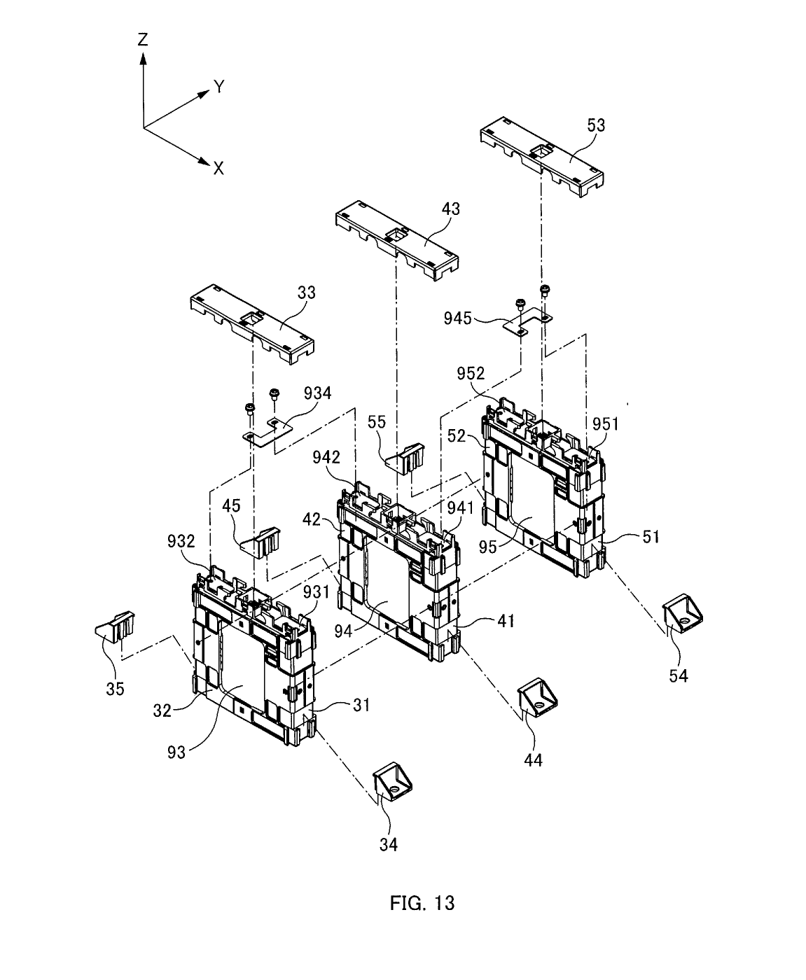

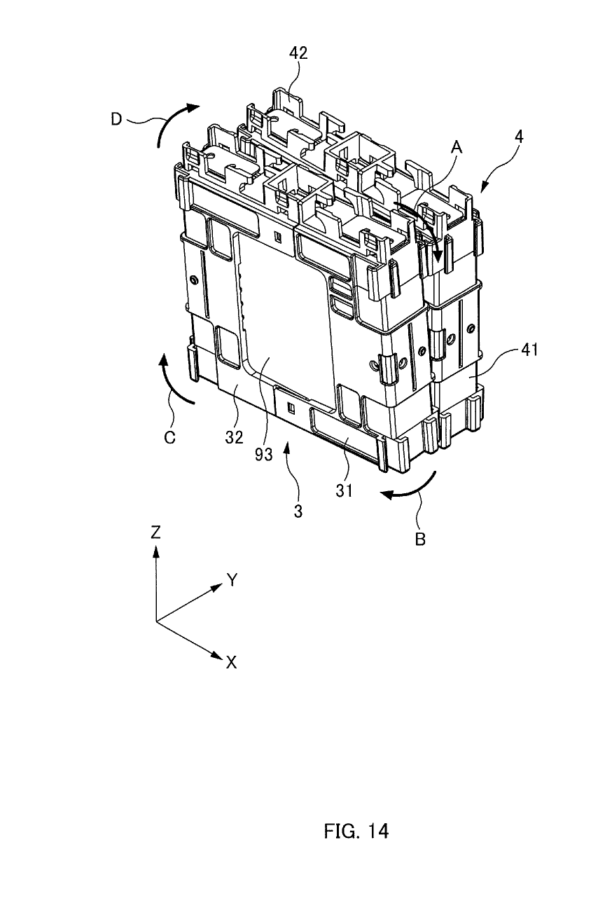

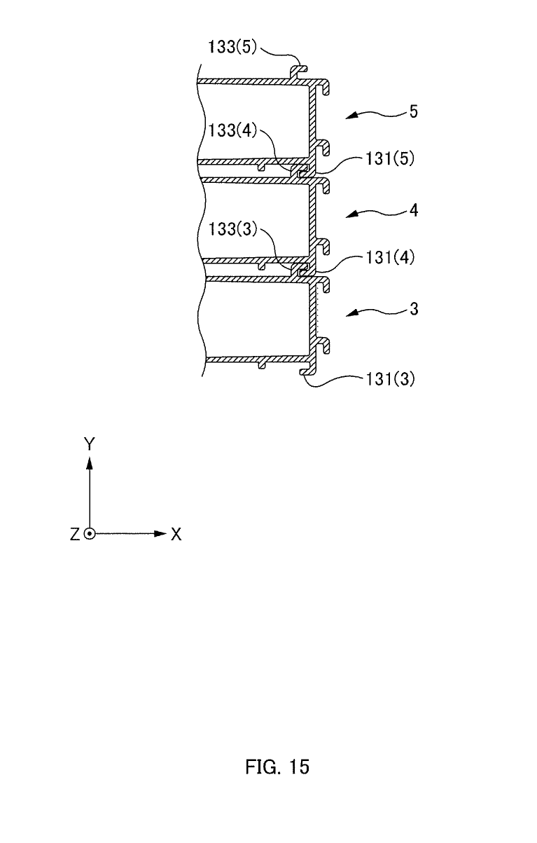

Subsequently, the usage mode 2, in which a plurality of the battery cases 1 are coupled in the thickness direction, will be described with reference to FIGS. 12 to 15. FIG. 12 is a perspective view illustrating the usage mode 2, FIG. 13 is an exploded view of FIG. 12, FIG. 14 is a diagram illustrating a way of coupling the battery cases 1 in the thickness direction, and FIG. 15 is a cross-sectional view of a state where a plurality of the battery cases 1 are coupled in the thickness direction. Note that, in FIG. 15, the configuration of the cell is omitted.

In the usage mode 2, as illustrated in FIG. 12, a plurality of battery cases are coupled in the thickness direction, to form a single unit of a battery device. Although three battery cases 3 to 5 are coupled in FIG. 12, the number of battery cases to be coupled is not limited thereto. Further, a configuration may be such that cells are incorporated in two of the three battery cases 3 to 5 and a control board (not shown) for controlling the cells to function as a battery device is incorporated in the remaining one battery case. Note that, in the usage mode 2, legs 34, 35, 44, 45, 54, 55 are mounted to the battery cases 3 to 5 so as to help the battery device to stand alone and/or fix the battery device to an installation site. When the battery device is fixed, for example, screws are inserted into screw holes that are respectively formed in legs, to fix the battery device to an installation target.

In order to assemble such a battery device according to the usage mode 2, as illustrated in FIG. 13, first, a first cover member 31 and a second cover member 32 are mounted to a cell 93, then, a first cover member 41 and a second cover member 42 are mounted to a cell 94, and a first cover member 51 and a second cover member 52 are mounted to a control board case 95. At this time, the cells and the control board case may be bonded to the inside of the battery covers. Then, the battery cases immediately adjacent to each other are coupled to each other.

A method of coupling the battery cases immediately adjacent to each other will be described, with coupling between the battery case 3 and the battery case 4 being used as an example. As illustrated in FIG. 14, the battery case 3 and the battery case 4 are overlaid in the thickness direction, with four corners of respective front wall and back wall thereof slightly deviating from each other.

More specifically, the battery case 3 and the battery case 4 are overlaid such that the substantially L-shape units 133, 232 of the battery case 3 come in contact with the depressed portions 141, 244 of the battery case 4. At this time, the restricting protrusion portion 151 of the battery case 3 is thrusted by the front wall 191 of the battery case 4, to elastically deform the leaf spring 153. Similarly, the restricting protrusion portion 251 of the battery case 4 is thrusted by the front wall 191 of the battery case 3, to elastically deform the leaf spring 253. With such an elastic deformation, the restricting protrusion portion 151 of the battery case 3 is pushed into the inside of the battery case 3, and the restricting protrusion portion 251 of the battery case 4 is pushed into the inside of the battery case 4.

In such a state, when one battery case is moved or rotated in a direction of arrows A to D as illustrated in FIG. 14, such that the four corners of the battery case 3 and those of the battery case 4 coincide with each other, then, as illustrated in FIG. 15, the tips of the substantially L-shape units 133, 134, 231, 232 of the battery case 3 are locked (engaged) with the tips of the substantially L-shape units 131, 132, 233, 234 of the battery case 4. Thereby, the battery case 3 and the battery case 4 are coupled. At this time, the restricting protrusion portion 151 of the battery case 3 moves to the position corresponding to that of the restricting hole portion 152 of the battery case 4, to be fitted into the restricting hole portion 152. Similarly, the restricting protrusion portion 251 of the battery case 4 moves to the position corresponding to that of the restricting hole portion 252 of the battery case 3, to be fitted into the restricting hole portion 252. Thereby, the battery case 3 and the battery case 4 are restrained from deviating from each other.

When the battery cases 3 to 5 are coupled as such, then, the battery cases immediately adjacent to each other are electrically connected to each other. Specifically, an electrode 932 of the cell 93 and an electrode 942 of the battery 94 are connected through a plate 934, as well as an electrode 941 of the battery 94 and an electrode 951 of the control board (or a battery) 95 are connected through a plate 945. Then, the electrode 932 of the cell 93 and an electrode 952 of the control board (or a battery) 95 are connected through a harness (not shown). At this time, the harness is inserted through the passage 181 or the passage 281, thereby simplifying the handling work of the harness that is performed by a worker.

Then, the battery cases 3, 4, 5 are covered with electrode covers 33, 43, 53, respectively. Further, the leg 34 is mounted to the substantially L-shape units 136, 138 of the battery case 3, the leg 35 is mounted to the substantially L-shape units 236, 238 of the battery case 3, the leg 44 is mounted to the substantially L-shape units 136, 138 of the battery case 4, the leg 45 is mounted to the substantially L-shape units 236, 238 of the battery case 4, the leg 54 is mounted to the substantially L-shape units 136, 138 of the battery case 5, the leg 55 is mounted to the substantially L-shape units 236, 238 of the battery case 5. Thereby, a single unit of a battery device is formed. In the usage mode 2 also, a screw is not used for assembling the battery device, except connecting in the electrical connection part, and thus the number of assembly parts is reduced.

Incidentally, the fit between the restricting protrusion portion 151 of the battery case 3 and the restricting hole portion 152 of the battery case 4 is released by elastically deforming the leaf spring 153 of the battery case 3, for example, using a tool such as a flathead screwdriver. In order to facilitate this release, as illustrated in FIG. 1, a depression 158 is formed between the holes 152 and 155. With the existence of this depression 158, a screwdriver is easily inserted between the leaf spring 153 of the battery case 3 and the front wall 191, facing the leaf spring 153, of the battery case 4, thereby improving the efficiency of such release work. Similarly, the fit between the restricting protrusion portion 251 of the battery case 4 and the restricting hole portion 252 of the battery case 3 is released by elastically deforming the leaf spring 253 of the battery case 4. In order to facilitate such release, a depression 258 that is formed between the holes 252 and 255 is utilized. When the fit between the restricting protrusion portion and the restricting hole portion is released as such, the lock (engagement) between the tips of the substantially L-shape units 133, 134, 231, 232 of the battery case 3 and the tips of the substantially L-shape units 131, 132, 233, 234 of the battery case 4 can be released, and further the coupling between the battery case 3 and the battery case 4 can be released. Accordingly, a predetermined tool is used for such release of the coupling of the battery cases according to an embodiment of the present disclosure. Thus, disassembling of the battery devices, for example, by mischief making can be restrained.

### (Usage Mode 3)

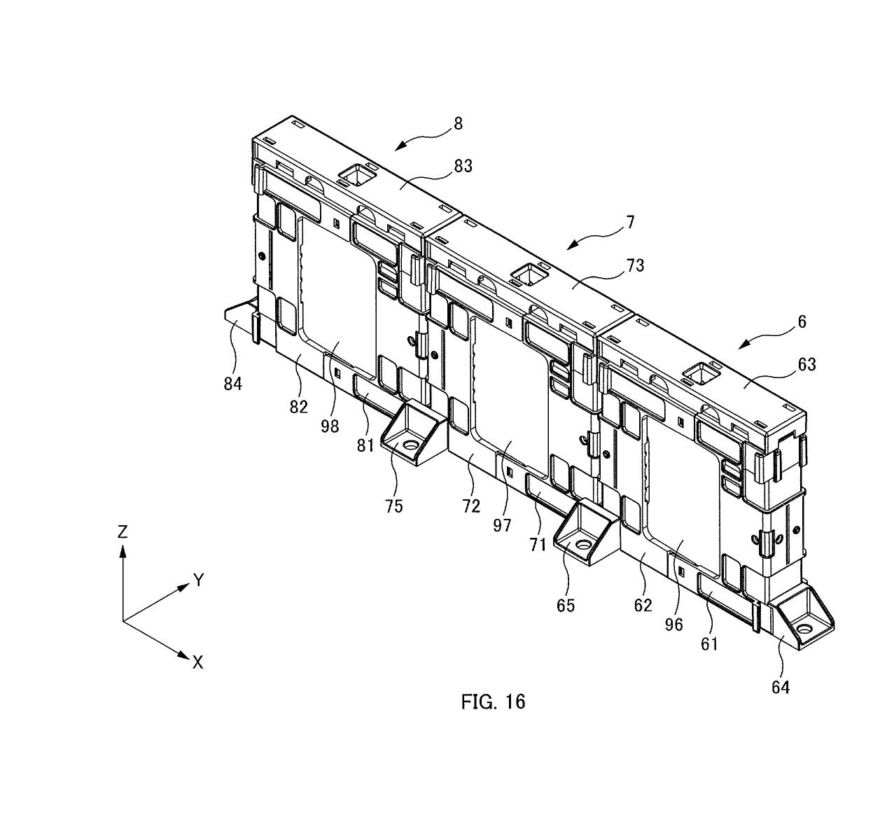

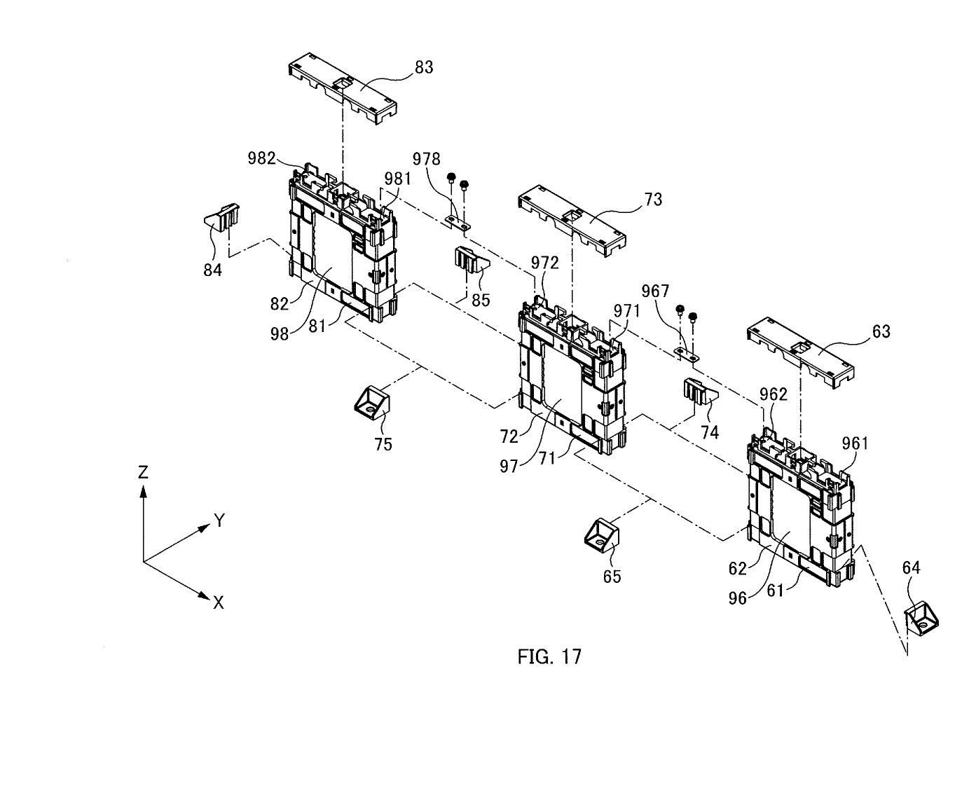

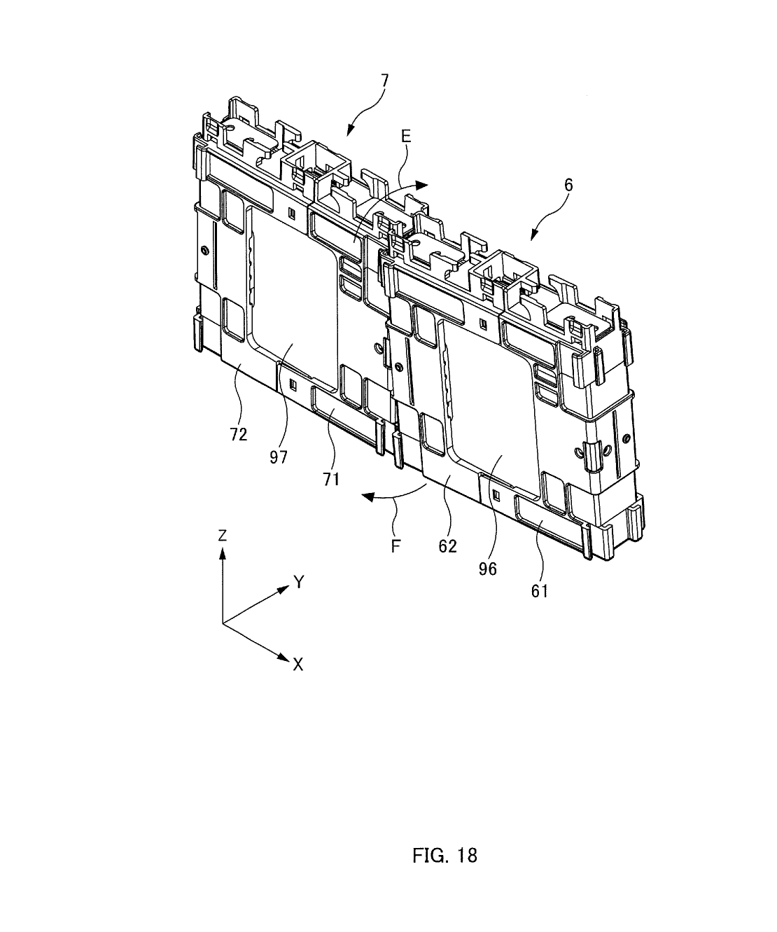

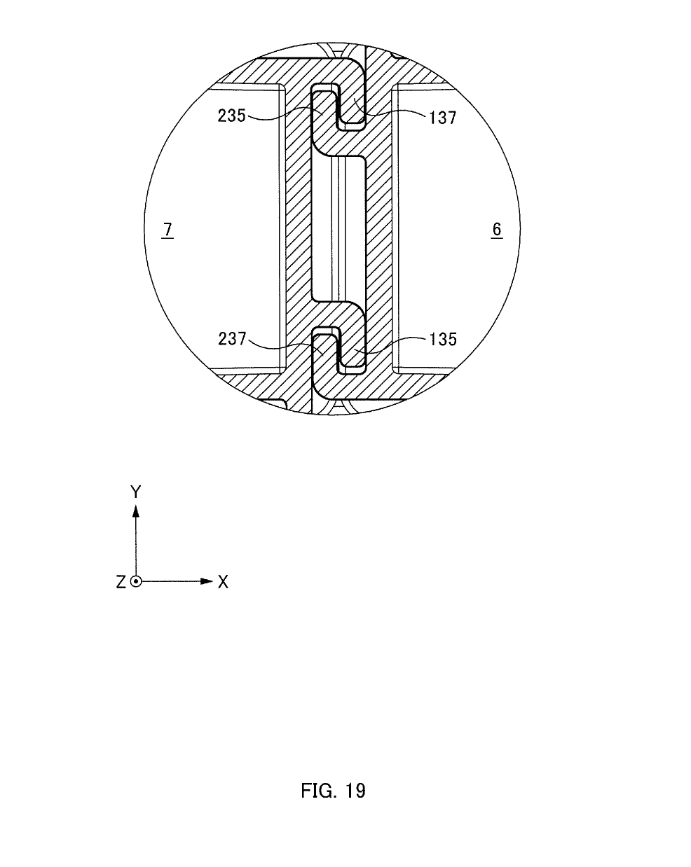

The usage mode 3, in which a plurality of the battery cases 1 is coupled in the width direction, will be described with reference to FIGS. 16 to 19. FIG. 16 is a perspective view illustrating the usage mode 3, FIG. 17 is an exploded view of FIG. 16, FIG. 18 is a diagram illustrating a state where the battery cases 1 are coupled in the width direction, and FIG. 19 is a cross-sectional view illustrating a state where the battery cases 1 are coupled in the width direction. Note that, in FIG. 19, the configuration of a cell is omitted.

In the usage mode 3, as illustrated in FIG. 16, a plurality of battery cases is coupled in the width direction, to form one single unit of a battery device. Although three battery cases 6 to 8 are coupled in FIG. 16, similarly to the usage mode 2, the number of the battery cases to be coupled is not limited. Further, a configuration may be such that cells are incorporated in two of the three battery cases 6 to 8, respectively, and a control board (not shown) for controlling the cells to function as a battery device is incorporated in the remaining one battery case. Note that, in the usage mode 3, legs 64, 65, 74, 75, 84, 85 are mounted to the battery cases 6 to 8 so as to help the battery device to stand alone and/or fix the battery device to an installation site.

In order to assemble such a battery device according to the usage mode 3, as illustrated in FIG. 17, first, a first cover member 61 and a second cover member 62 are mounted to a cell 96, then, a first cover member 71 and a second cover member 72 are mounted to a cell 97, and a first cover member 81 and a second cover member 82 are mounted to a control board (or a cell) 98. Thereafter, the battery cases immediately adjacent to each other are coupled in the width direction.

A method of coupling the battery cases immediately adjacent to each other will be described, with coupling between the battery case 6 and the battery case 7 being used as an example. As illustrated in FIG. 18, the battery case 6 and the battery case 7 are overlaid in the width direction, with four corners of the side walls thereof facing each other slightly deviating from each other.

More specifically, the battery case 6 and the battery case 7 are overlaid such that the substantially L-shape units 235, 236, 237, 238 of the battery case 6 are caused to correspond to the substantially L-shape units 137, 138, 135, 136 of the battery case 7, however, the tips of the substantially L-shape units thereof corresponding to each other do not come in contact with each other. At this time, the restricting protrusion portion 254 of the battery case 6 is thrusted by the right wall 193 of the battery case 7, to elastically deform the leaf spring 256. Similarly, the restricting protrusion portion 154 of the battery case 7 is thrusted by the left side surface of the battery case 6, to elastically deform the leaf spring 153. With such an elastic deformation, the restricting protrusion portion 254 of the battery case 6 is pushed into the inside of the battery case 6, and the restricting protrusion portion 154 of the battery case 7 is pushed into the inside of the battery case 7.

In such a state, when one battery case is moved or rotated in a direction of arrows E and F as illustrated in FIG. 18, such that the four corners of the battery case 6 and those of the battery case 7 coincide with each other, then, as illustrated in FIG. 19, the tips of the substantially L-shape units 235, 236, 237, 238 of the battery case 6 are locked (engaged) with the tips of the substantially L-shape units 137, 138, 135, 136 of the battery case 7, respectively. Thereby, the battery case 6 and the battery case 7 are coupled. At this time, the restricting protrusion portion 254 of the battery case 6 moves to the position corresponding to that of the restricting hole portion 155 of the battery case 7, to be fitted into the restricting hole portion 155. Similarly, the restricting protrusion portion 154 of the battery case 7 moves to the position corresponding to that of the restricting hole portion 255 of the battery case 6, to be fitted into the restricting hole portion 255. Thereby, the battery case 6 and the battery case 7 are restrained from deviating from each other.

When the battery cases 6 to 8 are coupled as such, then, the battery cases immediately adjacent to each other are electrically connected to each other. Specifically, an electrode 962 of the battery 96 and an electrode 971 of the battery 97 are connected through a plate 967, as well as an electrode 972 of a battery 97 and an electrode 981 of the control board (or a battery) 98 are connected through a plate 978. Then, an electrode 931 of the battery 96 and an electrode 982 of the control board (or a battery) 98 are connected through a harness (not shown). At this time, the harness is run through the outside of the battery cases 6 to 8, and thus, in one or more embodiments, is tied through a band on the attaching portion 185 or 285 of each of the battery cases.

Then, the battery cases 6, 7, 8 are covered with electrode covers 63, 73, 83, respectively. Further, the leg 64 is mounted to the substantially L-shape units 136, 138 of the battery case 6, the leg 65 is mounted to the substantially L-shape unit 234 of the battery case 6 and the substantially L-shape unit 132 of the battery case 7, the leg 74 is mounted to the substantially L-shape unit 232 of the battery case 6 and the substantially L-shape unit 134 of the battery case 7, the leg 75 is mounted to the substantially L-shape unit 234 of the battery case 7 and the substantially L-shape unit 132 of the battery case 8, the leg 84 is mounted to the substantially L-shape unit 232 of the battery case 7 and the substantially L-shape unit 134 of the battery case 8, and leg 84 is mounted to the substantially L-shape units 136, 138 of the battery case. However, in a case where the battery cases are provided such that the front wall or back wall of the battery cases comes in contact with a ground surface, such legs may not be applied.

Thereby, a single unit of a battery device in the usage mode 3 is formed. In the usage mode 3 also, a screw not is used for assembling the battery device, except connecting in the electrical connection part, and thus the number of assembly parts is reduced.

Incidentally, the fit between the restricting protrusion portion 254 of the battery case 6 and the restricting hole portion 155 of the battery case 7 is released by elastically deforming the leaf spring 253 of the battery case 6, for example, using a tool such as a flathead screwdriver. In order to facilitate this release, the depression 258 is formed between the holes 252 and 255. With the existence of this depression 258, a screwdriver is easily inserted between the leaf spring 253 of the battery case 6 and the right wall 193, facing the leaf spring 253, of the battery case 7, thereby improving the efficiency of such release work. Similarly, the fit between the restricting protrusion portion 154 of the battery case 7 and the restricting hole portion 255 of the battery case 6 is released by elastically deforming the leaf spring 153 of the battery case 7, using a predetermined tool. In order to facilitate such release, the depression 158 that is formed between the holes 152 and 155 is utilized. When the fit between the restricting protrusion portion and the restricting hole portion is released as such, the lock (engagement) between the tips of the substantially L-shape unit 235, 236, 237, 238 of the battery case 6 and the tips of the substantially L-shape units 137, 138, 135, 136 of the battery case 7 can be released, and further the coupling between the battery case 6 and the battery case 7 can be released. Accordingly, a predetermined tool is used for such release of the coupling of the battery cases according to an embodiment of the present disclosure. Thus, disassembling of the battery devices, for example, by mischief making can be restrained.

The battery case according to an embodiment of the present disclosure has various advantages. For example, the battery case 10 is configured including the first cover member 100 and the second cover member 200 having the same shape, and thus the number of parts that are required for the battery case 10 is reduced, to contribute to the reduction in the manufacturing costs. Further, the battery case 10 is assembled by fitting, and separate parts such as threads are not needed. Thus, the number of assembly parts is further reduced, to achieve the reduction in the manufacturing costs.

Further, the first coupling unit 130 and the second coupling unit 230 enable coupling of a plurality of the battery cases 10 in both the thickness direction and the width direction. This enhances degrees of freedom in providing a battery device including a plurality of the battery case 10. That is, the battery cases 10 according to an embodiment of the present disclosure, for example, can be arranged even in a narrow gap, and thus can be installed in places having various shapes.

Further, with the restricting unit 150 and the restricting unit 250, a plurality of the coupled battery case 10 can be restrained from moving unexpectedly. Thus, for example, even if some impact is exerted on the battery device configured with a plurality of the battery cases 10, disconnection which is caused by any of the battery cases 10 coming off, will not occur.

Further, the front walls 191, 291 and the back walls 192, 292 enable efficient release (dissipation) of the heat generated in the cell 90 to the outside, together with the groove portions 161, 162, 261, 262. That is, the battery case 10 is excellent in cooling the cell 90.

As has been described above, the battery case 10 includes: the first cover member 100 configured to be mounted to one region of the cell 90; and the second cover member 200 having a shape identical to the shape of the first cover member 100, the second cover member 200 being configured to be mounted to the other region opposite to the one region of the cell 90 and coupled to the first cover member 100. According to such an embodiment, the battery case can be configured with only a pair of cover members, and thus the number of parts that are necessary for the battery case can be reduced, thereby contributing the reduction in the manufacturing costs.

Further, the first cover member 100 may include the first locking unit 110 at the end of the first opening 160 into which one region of the cell 90 is to be inserted, and the second cover member 200 may include the second locking unit 210 at the end of the second opening 260 into which the other region of the cell 90 is to be inserted, the second locking unit 210 being configured to be locked with the first locking unit, so that the first cover member 100 and the second cover member 200 are coupled. According to such an embodiment, the first cover member 100 and the second cover member 200 are reliably locked through the first locking unit 110 and the second locking unit 210, and thus the cell 90 can reliably be held.

Furthermore, the first locking unit 110 may include: the hook parts 121, 122 protruding in a direction intersecting a direction in which the cell 90 is inserted into the first cover member 100; and the holes 123, 124, and the second locking unit 210 may include: the hook parts 221, 222 protruding in a direction intersecting a direction in which the cell 90 is inserted into the second cover member 200, to be fitted into the holes 123, 124; and the holes 223, 224 into which the hook parts 121, 122 are to be fitted. According to such an embodiment, the first cover member 100 and the second cover member 200 can detachably be mounted to the cell 90.

Further, the first cover member 100 may include the first coupling unit 130 configured to couple one battery case and another battery case, the one battery case including the first cover member 100 and the second cover member 200 that are configured to be mounted to one cell 90, and the second cover member 200 including the first cover member 100 and the second cover member 200 that are configured to be mounted to another cell 90, and the second cover member may include a second coupling unit 230 configured to couple one battery case and another battery case. According to such an embodiment, a plurality of the battery cases 10 can be coupled in a flexible manner through the first coupling unit 130 and the second coupling unit 230.

Further, the first coupling unit 130 may include: the third coupling unit configured to couple one battery case 10 and another battery case 10 along the first direction; and the fourth coupling unit configured to couple along the second direction different from the first direction. The second coupling unit 230 may include: the fifth coupling unit configured to couple one battery case 10 and another battery case 10 along the first direction; and the sixth coupling unit configured to couple one battery case 10 and another battery case 10 along the second direction. According to such an embodiment, a plurality of the battery cases 10 can be coupled in two different directions, and thus degrees of freedom in utilizing the battery cases 10 are enhanced.

By way of example, the third coupling unit may be configured to couple the first cover member 100 configured to be mounted to one cell 90 and the first cover member 100 configured to be mounted to another cell 90, in a state immediately adjacent to each other, and the fifth coupling unit may be configured to couple the second cover member 200 configured to be mounted to one cell 90 and the second cover member 200 configured to be mounted to another cell 90, in a state immediately adjacent to each other. Specifically, in one or more embodiments, the third coupling unit includes the first substantially L-shape units 131 to 134 configured to detachably couple the first cover member 100 configured to be mounted to one cell 90 and the first cover member 100 configured to be mounted to another cell 90, and the fifth coupling unit includes the second substantially L-shape units 231 to 234 configured to detachably couple the second cover member 200 configured to be mounted to one cell 90 and the second cover member 200 configured to be mounted to another cell 90. According to such embodiments, a plurality of the battery cases 10 can detachably be coupled, and thus the convenience of the battery case 10 is enhanced.

Additionally, the fourth coupling unit may be configured to couple the first cover member 100 configured to be mounted to one cell 90 and the second cover member 200 configured to be mounted to another cell 90, in a state immediately adjacent to each other, and the sixth coupling unit may be configured to couple the second cover member 200 configured to be mounted to one cell 90 and the first cover member 100 configured to be mounted to another cell 90, in a state immediately adjacent to each other. Specifically, in one or more embodiments, the fourth coupling unit includes the third substantially L-shape units 135 to 138 configured to detachably couple the first cover member 100 configured to be mounted to one cell 90 and the second cover member 200 configured to be mounted to another cell 90, and the sixth coupling unit includes the fourth substantially L-shape units 235 to 238 configured to detachably couple the second cover member 200 configured to be mounted to one cell 90 and the first cover member 100 configured to be mounted to another cell 90. According to these embodiments, a plurality of the battery cases 10 can be detachably coupled, and thus the convenience of the battery case 10 can be enhanced.

Further, the first cover member 100 may include the first restricting unit configured to, when one battery case 10 and another battery case 10 are coupled, restrict deviation from the immediately adjacent first cover member 100, with the substantially L-shape units 131 to 134, and the second cover member 200 may include the second restricting unit configured to, when one battery case 10 and another battery case 10 are coupled, restrict deviation from the immediately adjacent second cover member 200, with the substantially L-shape units 231 to 234. Specifically, in one or more embodiments, the first restricting unit includes the restricting protrusion portion 151 and the restricting hole portion 152, the second restricting unit includes the restricting protrusion portion 251 and the restricting hole portion 252, the restricting protrusion portion 151 of the first cover member 100 configured to be mounted to one cell 90 is fitted into the restricting hole portion 152 of the first cover member 100 configured to be mounted to another cell 90, the restricting hole portion 152 of the first cover member 100 configured to be mounted to one cell 90 is fitted with the restricting protrusion portion 151 of the first cover member 100 configured to be mounted to another cell 90, the restricting protrusion portion 251 of the second cover member 200 configured to be mounted to one cell 90 is fitted into the restricting hole portion 252 of the second cover member 200 configured to be mounted to another cell 90, and the restricting hole portion 252 of the second cover member 200 configured to be mounted to one cell 90 is fitted with the restricting protrusion portion 251 of the second cover member 200 configured to be mounted to another cell 90. According to these embodiments, a plurality of the coupled battery case 10 is reliably held without deviating from each other. Thus, even if some impact is exerted on the battery device, malfunction of the battery device which is caused by the battery cases deviating from each other, can be restrained.

In addition, in one or more embodiments, the first cover member 100 includes the third restricting unit configured to, when one battery case 10 and another battery case 10 are coupled, restrict deviation from the immediately second cover member 200, with the substantially L-shape units 135 to 138, and the second cover member 200 includes the fourth restricting unit configured to, when one battery case 10 and another battery case 10 are coupled, restrict deviation from the immediately adjacent first cover member 100, with the substantially L-shape units 235 to 238. Specifically, the third restricting unit may include the restricting protrusion portion 154 and the restricting hole portion 155, the fourth restricting unit may include the restricting protrusion portion 254 and the restricting hole portion 255, the restricting protrusion portion 154 of the first cover member 100 configured to be mounted to one cell 90 may be fitted into the restricting hole portion 255 of the second cover member 200 configured to be mounted to another cell 90, the restricting hole portion 155 of the first cover member 100 configured to be mounted to one cell 90 may be fitted with the restricting protrusion portion 254 of the second cover member 200 configured to be mounted to another cell 90, the restricting protrusion portion 254 of the second cover member 200 configured to be mounted to one cell 90 may be fitted into the restricting hole portion 155 of the first cover member 100 configured to be mounted to another cell 90, and the restricting hole portion 255 of the second cover member 200 configured to be mounted to one cell 90 may be fitted with the restricting protrusion portion 154 of the first cover member 100 configured to be mounted to another cell 90. According to these embodiments, a plurality of the coupled battery cases 10 is reliably held without deviating from each other. Thus, even if some impact is exerted on the battery device, malfunction of the battery device which is caused by the battery cases 10 deviating from each other, can be restrained.

Further, the first cover member 100 includes the leaf spring 153 configured to, when one battery case 10 and another battery case 10 are coupled, be elastically deformed in such a manner as to move the restricting protrusion portion 151 of the first cover member 100 configured to be mounted to one cell 90 away from the restricting hole portion 152 of the first cover member 100 configured to be mounted to another cell 90, until the restricting protrusion portion 151 is fitted into the restricting hole portion 152. The second cover member 200 includes the leaf spring 253 configured to, when one battery case 10 and another battery case 10 are coupled, be elastically deformed in such a manner as to move the restricting protrusion portion 251 of the second cover member 200 configured to be mounted to one cell 90 away from the restricting hole portion 252 of the second cover member 200 configured to be mounted to another cell 90, until the restricting protrusion portion 251 is fitted into the restricting hole portion 252. In addition, the first cover member 100 includes the leaf spring 156 configured to, when one battery case 10 and another battery case 10 are coupled, be elastically deformed in such a manner as to move the restricting protrusion portion 154 of the first cover member 100 configured to be mounted to one cell 90 away from the restricting hole portion 255 of the second cover member 200 configured to be mounted to another cell 90, until the restricting protrusion portion 154 is fitted into the restricting hole portion 255. The second cover member 200 includes the leaf spring 256 configured to, when one battery case 10 and another battery case 10 are coupled, be elastically deformed in such a manner as to move the restricting protrusion portion 254 of the second cover member 200 configured to be mounted to one cell 90 away from the restricting hole portion 155 of the first cover member 100 configured to be mounted to another cell 90, until the restricting protrusion portion 254 is fitted into the restricting hole portion 155. According to these embodiments, a plurality of the battery cases 10 is easily coupled, as well as coupling of a plurality of the battery cases 10 can be released, thereby improving workability.

Further, the first cover member 100 includes the first cutout 196,197 configured to partially expose one region of the cell 90, and the second cover member 200 includes the second cutout 296, 297 configured to partially expose the other region of the cell 90. Thereby, the heat generated in the cell 90 can efficiently be released to the outside of the battery case 10. Accordingly, cooling effect is excellent.

Further, in one or more embodiments, the first cover member 100 includes the third opening 171 configured to expose the first electrode 911 formed in one region of the cell 90, the second cover member 200 includes the fourth opening 271 configured to expose the second electrode 912 formed in the other region of the cell 90, and the battery case 10 further comprises the electrode cover 300 configured to cover the third opening 171 and the fourth opening 271. Such an embodiment can reliably restrain a short-circuit accident caused by the cell 90 coming in contact with the electrodes 911, 912.

Further, with the legs 34, 35, 44, 45, 54, 55, 64, 65, 74, 75, 84, 85, which are configured to be detachably mounted to the first coupling unit 130 and the second coupling unit 230, being further included, the battery case 10 can stably stand alone. Further, through these legs, the battery case 10 can be fixed to an installation site.

Hereinabove, embodiments according to the present disclosure have been described, but the present disclosure is not limited thereto. Materials, shapes, arrangements of members described above are merely embodiments to implement the present disclosure, and may variously be changed or altered without departing from the spirit of the disclosure.

What is claimed is:

1. A battery case comprising:
a first cover member configured to be mounted to one region of a cell, and
a second cover member having a shape identical to a shape of the first cover member, the second cover member being configured to be mounted to an other region opposite to the one region of the cell and coupled to the first cover member.

2. The battery case according to claim 1, wherein
the first cover member includes a first locking unit at an end of a first opening into which the one region of the cell is to be inserted, and
the second cover member includes a second locking unit at an end of a second opening into which the other region of the cell is to be inserted, the second locking unit being configured to be locked with the first locking unit,
so that the first cover member and the second cover member are coupled.

3. The battery case according to claim 2, wherein
the first locking unit includes
a first protrusion portion protruding in a direction intersecting a direction in which the cell is inserted into the first cover member, and
a first hole portion, and
the second locking unit includes
a second protrusion portion protruding in a direction intersecting a direction in which the cell is inserted into the second cover member, to be fitted into the first hole portion,
a second hole portion into which the first protrusion portion is to be fitted.

4. The battery case according to claim 1, wherein
the battery case comprises one and an other battery cases, the cell comprises one and an other cells, the first cover member comprises one and an other first cover members, and the second cover member comprises one and an other second comer members,
the first cover member includes a first coupling unit configured to couple one battery case and an other battery case, the one battery case including one first cover member and one second cover member that are configured to be mounted to one cell, the other battery case including an other first cover member and an other second cover member that are configured to be mounted to an other cell, and
the second cover member includes a second coupling unit configured to couple one battery case and an other battery case.

5. The battery case according to claim 4, wherein
the first coupling unit includes
a third coupling unit configured to couple one battery case and an other battery case along a first direction, and
a fourth coupling unit configured to couple one battery case and an other battery case along a second direction different from the first direction, and
the second coupling unit includes
a fifth coupling unit configured to couple one battery case and an other battery case along the first direction, and
a sixth coupling unit configured to couple one battery case and an other battery case along the second direction.

6. The battery case according to claim 5, wherein
the third coupling unit is configured to couple one first cover member configured to be mounted to one cell and an other first cover member configured to be mounted to an other cell, in a state immediately adjacent to each other, and
the fifth coupling unit is configured to couple one second cover member configured to be mounted to one cell and an other second cover member configured to be mounted to an other cell, in a state immediately adjacent to each other.

7. The battery case according to claim 6, wherein
the third coupling unit includes a first substantially L-shape unit configured to detachably couple one first cover member configured to be mounted to one cell and an other first cover member configured to be mounted to an other cell, and
the fifth coupling unit includes a second substantially L-shape unit configured to detachably couple one second cover member configured to be mounted to one cell and an other second cover member configured to be mounted to an other cell.

8. The battery case according to claim 7, wherein
the first cover member comprises an immediately adjacent first cover member, and the second cover member comprises an immediately adjacent second cover member,
the first cover member includes a first restricting unit configured to, when one battery case and an other battery case are coupled, restrict deviation from an immediately adjacent first cover member, with the first substantially L-shape unit, and
the second cover member includes a second restricting unit configured to, when one battery case and an other battery case are coupled, restrict deviation from an immediately adjacent second cover member, with the second substantially L-shape unit.

9. The battery case according to claim 8, wherein
the first restricting unit includes a first restricting protrusion portion and a first restricting hole portion,
the second restricting unit includes a second restricting protrusion portion and a second restricting hole portion,
the first restricting protrusion portion comprises one and an other first restricting protrusion portions, the first restricting hole portion comprises one and an other first restricting hole portions, the second restricting protrusion portion comprises one and an other second restricting protrusion portions, and the second restricting hole portion comprises one and an other second restricting hole portions,
one first restricting protrusion portion of one first cover member configured to be mounted to one cell is fitted into an other first restricting hole portion of an other first cover member configured to be mounted to an other cell,
one first restricting hole portion of one first cover member configured to be mounted to one cell is fitted with an other first restricting protrusion portion of an other first cover member configured to be mounted to an other cell,
one second restricting protrusion portion of one second cover member configured to be mounted to one cell is fitted into an other second restricting hole portion of an other second cover member configured to be mounted to an other cell, and
one second restricting hole portion of one second cover member configured to be mounted to one cell is fitted with an other second restricting protrusion portion of an other second cover member configured to be mounted to an other cell.

10. The battery case according to claim 9, wherein
the first cover member includes a first elastic portion configured to, when one battery case and an other battery case are coupled, be elastically deformed in such a manner as to move one first restricting protrusion portion of one first cover member configured to be mounted to one cell away from an other first restricting hole portion of an other first cover member configured to be mounted to an other cell, until the one first restricting protrusion portion is fitted into the other first restricting hole portion, and
the second cover member includes a second elastic portion configured to, when one battery case and an other battery case are coupled, be elastically deformed in such a manner as to move one second restricting protrusion portion of one second cover member configured to be mounted to one cell away from an other second restricting hole portion of another second cover member configured to be mounted to an other cell, until the one second restricting protrusion portion is fitted into the other second restricting hole portion.

11. The battery case according to claim 6, wherein
the fourth coupling unit is configured to couple one first cover member configured to be mounted to one cell and an other second cover member configured to be mounted to an other cell, in a state immediately adjacent to each other, and
the sixth coupling unit is configured to couple one second cover member configured to be mounted to one cell and an other first cover member configured to be mounted to an other cell, in a state immediately adjacent to each other.

12. The battery case according to claim 11, wherein
the fourth coupling unit includes a third substantially L-shape unit configured to detachably couple one first cover member configured to be mounted to one cell and an other second cover member configured to be mounted to an other cell, and
the sixth coupling unit includes a fourth substantially L-shape unit configured to detachably couple one second cover member configured to be mounted to one cell and an other first cover member configured to be mounted to an other cell.

13. The battery case according to claim 12, wherein
the first cover member comprises an immediately adjacent first cover member, and the second cover member comprises an immediately adjacent second cover member,
the first cover member includes a third restricting unit configured to, when one battery case and an other battery case are coupled, restrict deviation from an immediately adjacent second cover member, with the third substantially L-shape unit, and
the second cover member includes a fourth restricting unit configured to, when one battery case and an other battery case are coupled, restrict deviation from an immediately adjacent first cover member, with the fourth substantially L-shape unit.

14. The battery case according to claim 13, wherein
the third restricting unit includes a third restricting protrusion portion and a third restricting hole portion,
the fourth restricting unit includes a fourth restricting protrusion portion and a fourth restricting hole portion,
the third restricting protrusion portion comprises one and an other third restricting protrusion portions, the third restricting hole portion comprises one and an other third restricting hole portions, the fourth restricting protrusion portion comprises one and an other fourth restricting protrusion portions, and the fourth restricting hole portion comprises one and an other fourth restricting hole portions,
one third restricting protrusion portion of one first cover member configured to be mounted to one cell is fitted into an other fourth restricting hole portion of an other second cover member configured to be mounted to an other cell,
one third restricting hole portion of one first cover member configured to be mounted to one cell is fitted with an other fourth restricting protrusion portion of an other second cover member configured to be mounted to an other cell,
one fourth restricting protrusion portion of one second cover member configured to be mounted to one cell is fitted into an other third restricting hole portion of an other first cover member configured to be mounted to an other cell, and
one fourth restricting hole portion of one second cover member configured to be mounted to one cell is fitted with an other third restricting protrusion portion of an other first cover member configured to be mounted to an other cell.

15. The battery case according to claim 14, wherein
the first cover member includes a third elastic portion configured to, when one battery case and an other battery case are coupled, be elastically deformed in such a manner as to move one third restricting protrusion portion of one first cover member configured to be mounted to one cell away from an other fourth restricting hole portion of an other second cover member configured to be mounted to an other cell, until the one third restricting protrusion portion is fitted into the other fourth restricting hole portion, and
the second cover member includes a fourth elastic portion configured to, when one battery case and an other battery case are coupled, be elastically deformed in such a manner as to move one fourth restricting protrusion portion of one second cover member configured to be mounted to one cell away from an other third restricting hole portion of an other first cover member configured to be mounted to an other cell, until the one fourth restricting protrusion portion is fitted into the other third restricting hole portion.

16. The battery case according to claim 1, wherein
the first cover member includes a first cutout configured to partially expose the one region of the cell, and
the second cover member includes a second cutout configured to partially expose the other region of the cell.

17. The battery case according to claim 2, wherein
the first cover member includes a third opening configured to expose a first electrode formed in the one region of the cell,
the second cover member includes a fourth opening configured to expose a second electrode formed in the other region of the cell, and
the battery case further comprises an electrode cover configured to cover the third opening and the fourth opening across the first cover member and the second cover member.

18. The battery case according to claim 4, further comprising
leg portions configured to be detachably mounted to the first coupling unit and the second coupling unit.

19. A Power storage device, comprising:
a cell, and
the first and second cover members according to claim 1,
the power storage device being configured such that the cell is housed in an interior space formed by the first cover member and the second cover member.

20. A manufacturing method of a power storage device comprising:
preparing first and second covers having an identical shape, the first and second covers each including an opening into which a cell is to be inserted;
inserting one region of the cell into the opening of the first cover member, and inserting an other region of the cell into the opening of the second cover member, so that the first and second cover members are coupled; and
fitting a protrusion portion provided near the opening of the second cover member into a hole portion provided near the opening of the first cover member so that the first and second cover members are coupled, with the cell being housed therein.
